(19) United States
(12) Patent Application Publication
(10) Pub. No.: US 2013/0018624 A1
(43) Pub. Date: Jan. 17, 2013

(54) System For Manufacturing Cables

(71) Applicants: Anuj Bhatnagar, Sunnyvale, CA (US); James L. McPeak, Fremont, CA (US)

(72) Inventors: Anuj Bhatnagar, Sunnyvale, CA (US); James L. McPeak, Fremont, CA (US)

(21) Appl. No.: 13/183,431

(22) Filed: Jul. 15, 2011

(51) Int. Cl. G06F 19/00

(52) U.S. Cl. 702/119

(57) ABSTRACT

During manufacturing, devices under test may be tested at test stations. Test cables may be used to couple the test stations to the devices under test. To ensure that cables have been assembled properly, a test system may be used to convey test data through the cables. Status indictors in the cables can be activated using the test data. The test system may include a test board for performing loop-back tests. During testing, test data may be transmitted through the cable to the test board. The test board may convert the test data from a first format such as a Universal Serial Bus format to a second format such as a Universal Asynchronous Receiver Transmitter format. Test signals that have been received by the test board may be sent back to the cable to direct the cable to activate the status indicators.

### BACKGROUND

This relates to testing, and, more particularly, to systems for manufacturing electronic equipment such as cables.

Electronic devices such as portable computers, media players, cellular telephones, set-top boxes, and other electronic equipment must generally be tested prior to delivery to consumers. During testing, an electronic device that is being tested is often referred to as a device under test. In a typical scenario, a device under test may be passed through multiple test stations. At each test station, the device under test may be coupled to a different set of device under test test equipment. Different types of test stations may communicate with the device under test using different types of communications links. For example, some test stations may communicate with the device under test using a Universal Serial Bus (USB) path, whereas other test stations may communicate with the device under test using a Universal Asynchronous Receiver/Transmitter (UART) path.

It may be desirable to produce cables that support communications using multiple communications protocols. For example, it may be desirable to produce test cables that contain USB and UART signal paths. Such cables should be defect free to ensure that manufacturing tests that rely on use of the cables are performed satisfactorily.

It would therefore be desirable to be able to provide improved equipment for manufacturing cables such as cables that support multiple communications paths.

### SUMMARY

During manufacturing, devices under test may be tested at test stations. Test cables may be used to couple the test stations to the devices under test. A test station may load data onto the devices under test using a first path in a test cable. For example, a test station may load a test operating system onto a device under test using a Universal Serial Bus path in the test cable. The test station may also communicate with the device under test using a second path in the test cable. For example, a Universal Asynchronous Receiver Transmitter path may be used to convey test commands to the device under test from a test station and may be used to receive test data from the device under test at the test station.

To ensure that cables such as test cables for the test stations have been assembled properly, a test system may be used to convey test data through the cables. Status indicators in the cables can be activated using the test data. The test system may include a test board for performing loop-back tests. During testing, test data may be transmitted through the cable to the test board. The test board may convert the test data from a first format such as a Universal Serial Bus format to a second format such as a Universal Asynchronous Receiver Transmitter format. Test signals that have been received by the test board may be sent back to the cable to direct the cable to activate the status indicators. Successful activation of the status indictors may be used to confirm that the test cable is operating properly and is suitable for installation at a test station.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative device under test and an associated test cable in accordance with an embodiment of the present invention.

FIG. 2 is a diagram of illustrative programming and test equipment for programming and testing a cable such as the test cable of FIG. 1 in accordance with an embodiment of the present invention.

FIG. 3 is a diagram of an illustrative test cable that may be manufactured and tested using programming and test equipment of the type shown in FIG. 2 in accordance with an embodiment of the present invention.

FIG. 4 is a diagram of an illustrative cable such as a test coupled to programming equipment during cable programming in accordance with an embodiment of the present invention.

FIG. 5 is a diagram of an illustrative programmed cable such as a test cable that may be used to couple a device under test to a test station in accordance with an embodiment of the present invention.

FIG. 6 is a diagram of an illustrative programmed cable such as a test cable of the type shown in FIG. 5 coupled to test equipment during cable testing in accordance with an embodiment of the present invention.

FIG. 7 is a flow chart of illustrative steps involved in manufacturing cables such as test cables in accordance with an embodiment of the present invention.

### DETAILED DESCRIPTION

Electronic devices such as cellular telephones, media players, computers, set-top boxes, wireless access points, and other electronic equipment may be tested and loaded with software during manufacturing. During these operations, electronic devices may be referred to as devices under test (DUT). Following testing, a device that has passed its tests may be shipped to a customer. DUT test equipment may be used during testing of devices under test. The DUT test equipment may be programmed and tested during manufacturing using programming and test systems. For example, test cables may be programmed and tested. Following testing, the test cables may be used in factories to test devices under test as part of a manufacturing process. Cables that are manufactured using the programming and test systems may also be used in other applications (e.g., to interconnect user equipment in non-testing environments).

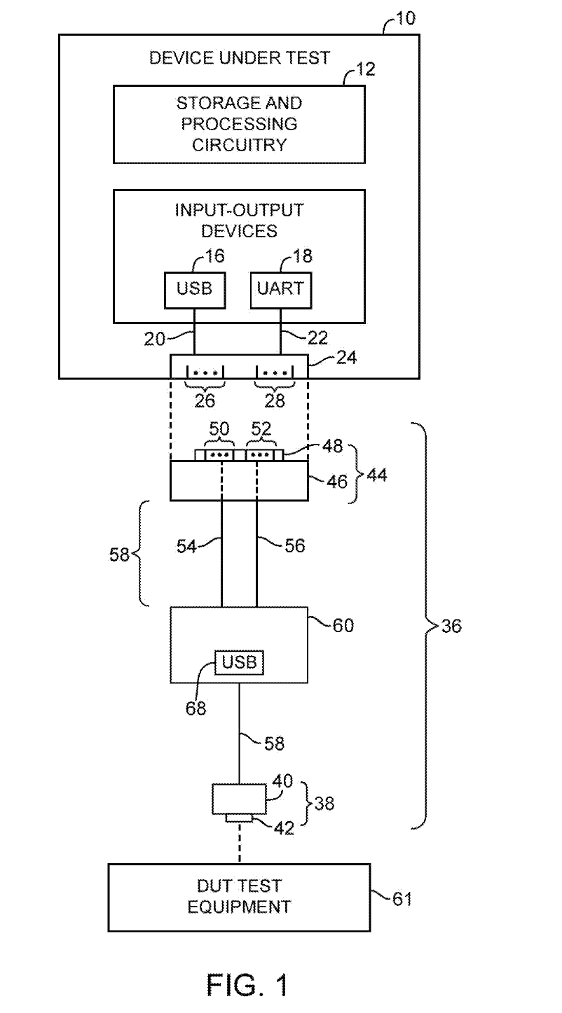

An illustrative electronic device of the type that may be tested during manufacturing is shown in FIG. 1. As shown in FIG. 1, device under test 10 may be coupled to test cable 36 for testing of device under test 10. Device under test 10 may be fully or partly assembled computer, a media player, a cellular telephone, a monitor with an integrated computer, a wireless access point, a set-top box, or other electronic equipment.

As shown in FIG. 1, device under test 10 may include storage and processing circuitry 12 and input-output devices 14. Storage and processing circuitry 12 may include microprocessors, microcontrollers, digital signal processor integrated circuits, application-specific integrated circuits, and other processing circuitry. Volatile and non-volatile memory circuits such as random-access memory, read-only memory, hard disk drive storage, solid state drives, and other storage circuitry may also be included in storage and processing circuitry 12.

Storage and processing circuitry 12 may use input-output devices 14 to obtain user input and to provide output to a user. Input-output devices 14 may include speakers, microphones, sensors, buttons, keyboards, displays, touch sensors, wireless circuitry such as wireless local area network transceiver circuitry and cellular telephone network transceiver circuitry, and other components for receiving input and supplying output.

Device under test 10 may include one or more input-output ports. For example, device under test 10 may include a connector such as connector 24 for forming a data input-output port. Connector 24 may have a number of contacts (sometimes referred to as pins). When a mating connector is plugged into connector 24, contacts (pins) on the mating connector will make electrical connections with the contacts in connector 24. Data may then be conveyed between device under test 10 and equipment that is electrically connected to the mating connector. In a normal (non-testing) environment, connector 24 may be used to couple the device to external equipment such as a computer or accessory (as examples). During testing, connector 24 may be coupled to test cable 36 using mating connector 46. During testing, cable 36 may be used to handle test data (e.g., test commands and test results) from device under test test equipment 61. Cable 36 may also be used in loading an operating system and other software from DUT test equipment 61 onto the device under test. In non-test environments, cables such as cable 36 may be used in interconnecting other electronic equipment.

Different sets of contacts in connector 24 may be associated with different communications buses and different associated communications protocols. For example, device under test 10 may use a first communications circuit such as Universal Serial Bus (USB) communications circuit 16 (e.g., a USB endpoint) to handle USB communications (USB data) through contacts 26 and may use a second communications circuit such as Universal Asynchronous Receiver Transmitter (UART) communications circuit 18 to handle UART communications (UART data) through contacts 28. Using USB communications protocols and USB circuit 16, device under test 10 can communicate over a USB bus coupled to contacts 26. Using UART communications protocols and UART circuit 18, device under test 10 can communicate over a UART bus coupled to contacts 28.

Different buses and protocols may be suitable for handling different types of communications traffic. For example, USB communications may be suitable for loading test software (test programs) onto device under test 10, for conveying test logs and other such test results that are generated by the test programs from device under test 10 to external DUT test equipment, and for loading an operating system or other code from DUT test equipment to device under test 10 following successful test operations. UART communications may be suitable for transferring test commands from external DUT test equipment to device structures under test 10. For example, UART communications may be used to send a “baseband power up” command from external DUT test equipment to a baseband processor integrated circuit or other wireless communications circuit in device under test 10. As another example, DUT test equipment may use UART communications to send a “video on” or “video off” test command to video circuitry in device under test 10 or may send commands to device under test 10 that that exercise audio circuitry in device under test 10. UART communications may also be used by DUT test equipment that is coupled to device under test 10 when the DUT test equipment wants to query device under test 10 for test results.

DUT test equipment for testing device under test 10 of FIG. 1 may include one or more test cables such as test cable 36, one or more computers, dedicated test units that perform test functions, and other suitable computing equipment.

Test cable 36 may have interface circuitry 60 that converts USB traffic from DUT test equipment into USB and

UART traffic for respectively communicating with USB circuit 16 and UART circuit 18 in device under test 10. As shown in FIG. 1, cable 36 may have a first end that is terminated with connector 38 and an opposing second end that is terminated with connector 44. Connector 38 may be a USB connector having a housing such as housing 40 that is used to house USB connector structure 42. Connector structure 42 may mate with a corresponding connector structure in DUT test equipment or other equipment or may mate with equipment for programming and testing cable 36. Connector 44 may be a connector such as a 30-pin data connector or a connector with any other suitable number of contacts. As shown in FIG. 1, connector 44 may have a connector housing such as housing 46 in which connector structure 48 (e.g., a 30-pin connector structure or other connector structure) is mounted. Connector structure 48 may be configured to mate with connector 24 of device under test 10 or with a corresponding connector of programming and test equipment for programming and testing cable 36.

When mated to connector 24 of device under test 10, contacts (pins) 50 of connector 44 may mate with corresponding contacts 26 in connector 24 and contacts (pins) 52 of connector 44 may mate with corresponding contacts 28 in connector 24. In general, connectors 38 and 44 may be implemented using any suitable types of connectors (e.g., USB, mini USB, Firewire®, 30-pin, Ethernet, audio connectors such as TRRS connectors, video connectors such as DVI, VGA, and HDMI connectors, or other types of signal connectors). The use of USB and 30-pin connectors at the ends of cable 36 of FIG. 1 is merely illustrative.

As shown in FIG. 1, at connector 44, cable path 58 may include wires such as wires 54 that are connected to contacts 50 in connector structure 48 and may include wires such as wires 56 that are connected to contacts 52 in connector structure 48. The portion of wired path 58 between connector 38 and circuitry 60 may include wires for coupling USB connector 38 to USB communications circuitry (USB endpoint) 68.

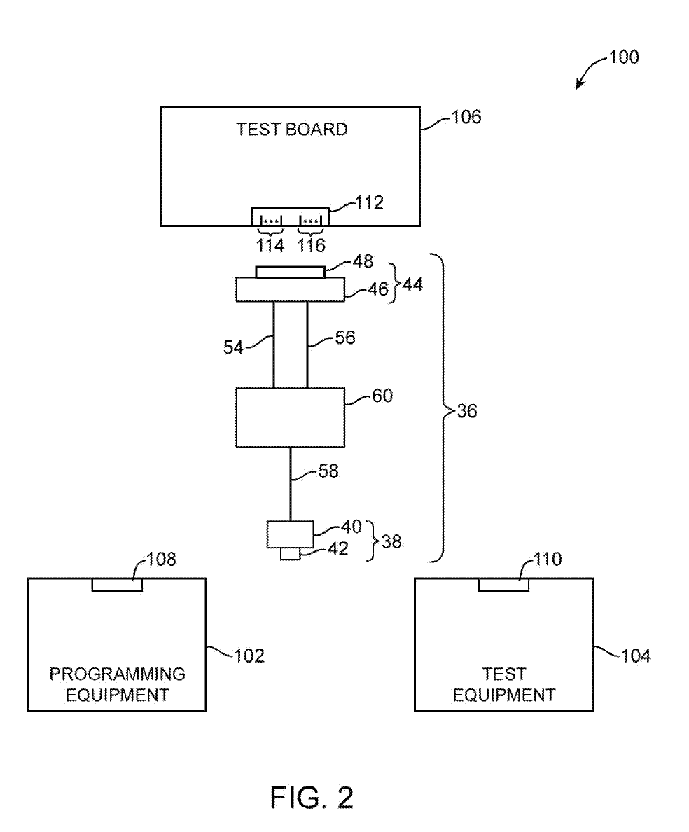

Connectors 44 and 38 may be coupled using cable paths 58. Cable paths 58 may include wires (e.g., wires bundled to form cables or other wired paths). Data conversion circuitry 60 may be interposed in the wired path between connectors 44 and 38. Data conversion circuitry 60 may include configurable (programmable) chips, data control logic circuitry, status indicator circuitry or other circuitry. During manufacturing of cables 36, data control circuitry 60 may be configured and verified using programming and test systems such as programming and test system 100 of FIG. 2.

As shown in FIG. 2, programming and test system 100 may include programming equipment 102, test equipment 104 and test board 106. Programming equipment 102 may have one or more USB ports such as ports formed from USB connector 108. One or more test cables 36 may be connected to programming equipment 102 by plugging connectors such as connector 38 into USB connectors such as USB connector 108. Programming equipment 102 may be used to load configuration software (configuration data) into cable 36 in order to program configurable components such as programmable integrated circuits in circuitry 60 of test cable 36.

Test equipment 104 may have one or more USB ports such as ports formed from USB connector 110. One or more test cables 36 may be connected to test equipment 104 by plugging connectors such as connector 38 into USB connectors such as USB connector 110. Test equipment 104 may be used for testing cable 36 during manufacturing. For example, test equipment 104 may perform tests on cable 36 to verify that cable 36 has been programmed properly and is functioning properly (viability verification tests).

Test board 106 may be formed from one or more printed circuit boards with attached integrated circuits and other components and may, if desired, be mounted in a housing. Test board 16 may have one or more connectors such as connector 112 for forming data input-output ports. Connector 112 may have a number of contacts (sometimes referred to as pins). Test board 106 may be coupled to cable 36 by plugging connector 44 into connector 112 such that contacts (pins) on connector structure 48 of connector 44 make electrical connections with contacts 114 and 116 in connector 112. Data may then be conveyed between cable 36 and test board 106. During testing of circuitry 60 of cable 36, board 106 may be used to form a loop-back path. The loop-back path of board 106 may be used to loop test data at is received at connector 112 from cable 36 back onto cable 36. As part of the loop-back process, the looped-back test data may, if desired, be converted from one communications protocol to another communications protocol (e.g., by converting USB data to UART data or converting UART data to USB data). This allows both types of communications paths (e.g., both the USB path in cable 36 and the UART path in cable 36) to be tested simultaneously. If either of these paths contains a defect, loop-back testing with board 106 will fail and test equipment 104 can be used to alert an operator of a fault with cable 36.

During manufacturing (e.g., during assembly, programming, testing and/or other manufacturing steps associated with manufacturing cable 36), connector 38 may be connected to connector 108 of programming equipment 102. Programming equipment 102 may program programmable components in test cable 36. Cable 36 may then be connected to connector 110 of test equipment 104 for component testing. During component testing of test cable 36, connector 44 of test cable 36 may be connected to connector 112 of test board 106 to allow loop-back tests to be performed.

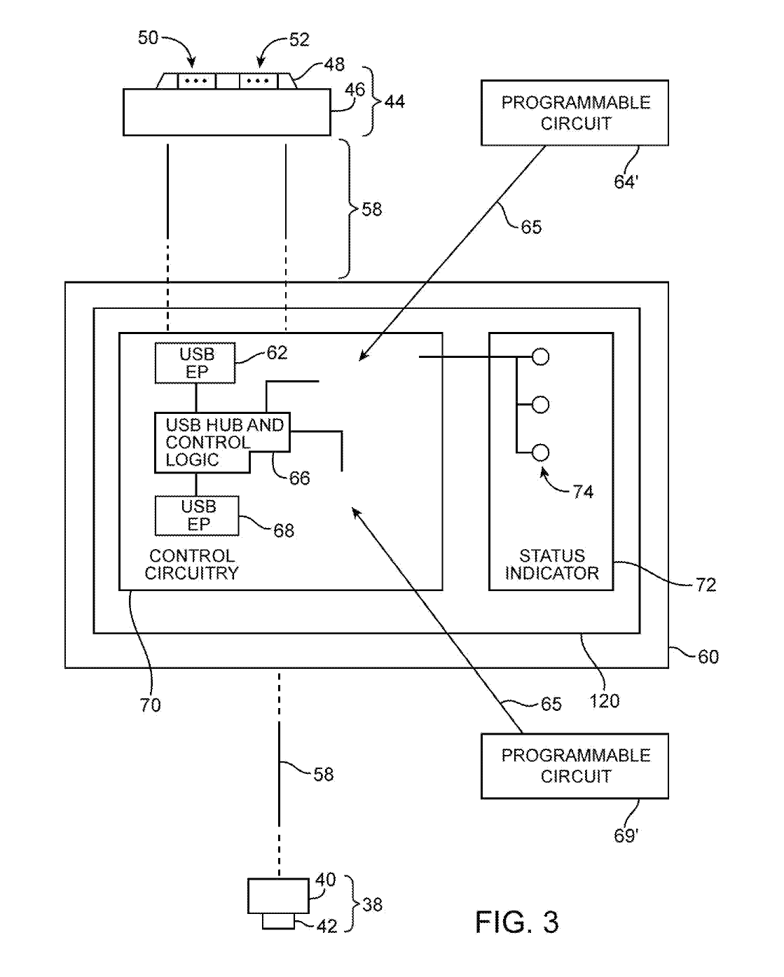

A diagram of an illustrative system that may be used during manufacture of cable 36 is shown in FIG. 3. As shown in FIG. 3, data conversion circuitry 60 of cable 36 may be assembled on a circuit board such as circuit board 120 (e.g., one or more printed circuit boards that are installed in a housing). Circuit board 120 may include control circuitry 70 and status indicator 72. Status indicator 72 and control circuitry 70 may be formed as portions of a single circuit board 120 or, if desired, circuit board 120 may be formed from several distinct circuit boards.

During manufacturing, cable 36 may be formed by mounting control circuit components such as USB communications circuitry (circuitry for implementing USB endpoints 62 and 68) and USB hub and control logic circuitry 66 to printed circuit board 120 in the form of one or more integrated circuits. Additional circuitry such as circuits 64′ and 69′ may be mounted to printed circuit board 120 in the form of one or more integrated circuits during assembly of cable 36 (as indicated by arrows 65). With one suitable arrangement, circuits 64′ and 69′ may be programmable integrated circuits from Future Technology Devices International Ltd. of Glasgow, United Kingdom. In general, circuitry 60 may be implemented using one or more integrated circuits from one or more different integrated circuit manufacturers.

Status indicator components such as one or more light-emitting diodes 74, lamps, audio components such as speakers or tone generators, or any other suitable components for generating visual and/or audible status output for an operator may also be attached to printed circuit board 120. In the example of FIG. 3, status indicator 72 includes three light-emitting components (e.g., light-emitting diodes). These light-emitting diodes may, if desired, be color coded. For example, the light-emitting diodes may be color-coded green, yellow, and red. If desired, other numbers of light-emitting components, light-emitting components with different colors, and other status indicator components may be used in status indicator 72. The example of FIG. 3 that uses red, green, and yellow light sources is merely illustrative.

During assembly of test cable 36, cable paths 58 may be electrically coupled to PCB 120. Cable paths 58 may include wires (e.g., wires bundled to form cables or other wired paths). As shown in FIG. 3, the process of assembling cable 36 may involve connecting cable path 58 to connector 44. At connector 44, cable path 58 may be connected to connector 44 by attaching wires such as wires 54 to contacts 50 in connector structure 48 and wires such as wires 56 to contacts 52 in connector structure 48. The portion of wired path 58 between connector 38 and circuitry 60 may be connected by attaching wires for coupling USB connector 38 to USB communications circuitry (USB endpoint) 68 to PCB 120 and by attaching wires such as wires 58 to USB connector structure 42 in connector structure 38. Following attachment of connectors 38 and 44 to wired path 58 and wired path 58 to PCB 120, wired path 54 have an electrical coupling to USB communications circuitry (USB endpoint) 62. Wired path 56 may have an electrical coupling to programmable integrated circuit 64′. Wired bath 58 connecting connector 38 to PCB 120 may have an electrical coupling to USB communications circuitry 68.

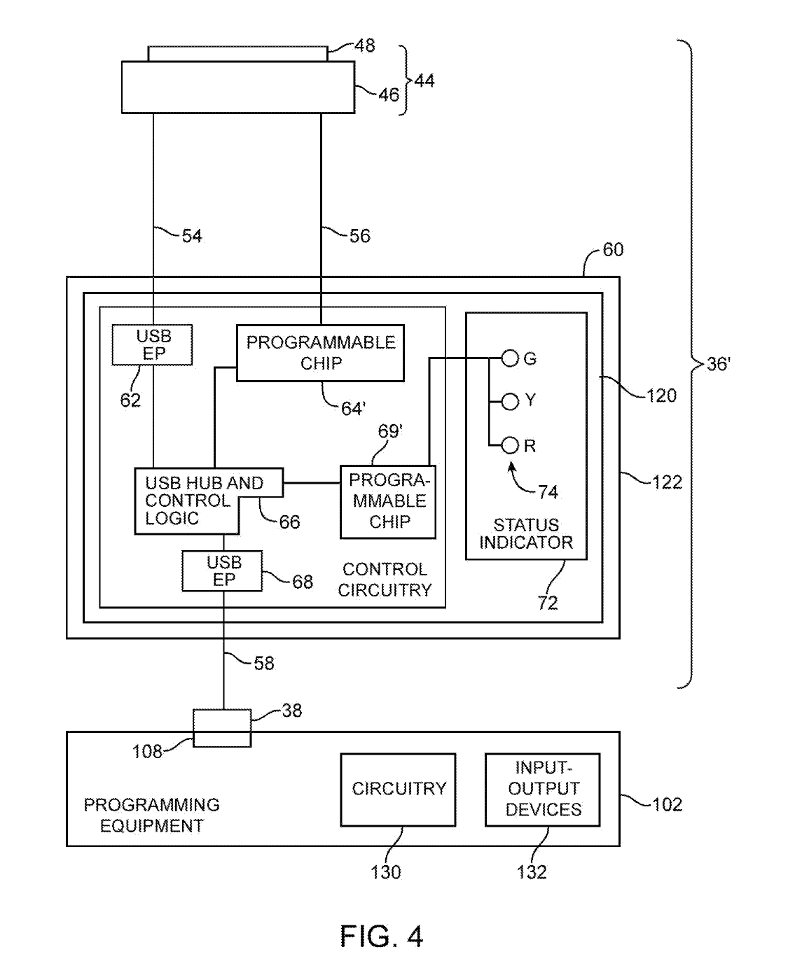

Following the attachment of components to PCB 120, circuitry 60 may be mounted in a housing such as housing 122 of FIG. 4. FIG. 4 is a diagram of an illustrative configuration that may be used for data conversion circuitry 60 of cable 36 during manufacturing. As shown in FIG. 4, assembled cable 36′ may include control circuitry 70 that includes USB communications circuitry 62 and 68, USB hub and control logic circuitry 66 and programmable chips 64′ and 69′ (e.g., programmable integrated circuits).

Assembled cable 36′ may include a status indicator for providing test status information to an operator of the test system. As described in connection with FIG. 3, status indicator 72 may include a display, one or more light-emitting diodes 74, or other components. In the example of FIG. 4, status indicator 72 includes a red, a yellow and a green light-emitting component (e.g., light-emitting diodes). If desired, other numbers of light-emitting components, light-emitting components with different colors, and other status indicator components may be used in status indicator 72. LEDs 74 of status indicator 72 may be electrically coupled to programmable chip 69′. LEDs 74 may be mounted in housing 122 such that a portion of LEDs 74 are visible to an operator of equipment connected to test cable 36 during programming and testing of test cable 36.

As shown in FIG. 4, during manufacturing of cable 36, assembled cable 36′ may be connected to programming equipment by plugging connector 38 of assembled cable 36′ into USB connector 108 of programming equipment 102.

Programming equipment 102 may have circuitry 130 for loading configuration data into assembled cable 36′ to configure programmable chips 64′ and 69′ to perform desired circuit functions. Programming equipment 102 may include input-output devices 132 for accepting input and delivering feedback to an operator of programming equipment 102 during programming of assembled cable 36′. Input-output devices 132 may include speakers, microphones, sensors, buttons, keyboards, displays, touch sensors, wireless circuitry such as wireless local area network transceiver circuitry and cellular telephone network transceiver circuitry, and other components for receiving input and supplying output.

Programming equipment 102 may be used to configure programmable integrated circuit 64′ to convert incoming data using USB or UART communications protocols to outgoing data using UART or USB communications protocols respectively. Programming equipment 102 may be used to configure programmable integrated circuit 69′ to convert incoming data using USB communications protocols to General Purpose Input-Output (GPIO) signals. GPIO signals may be used, as an example, to control LEDs 74 of status indicator 72.

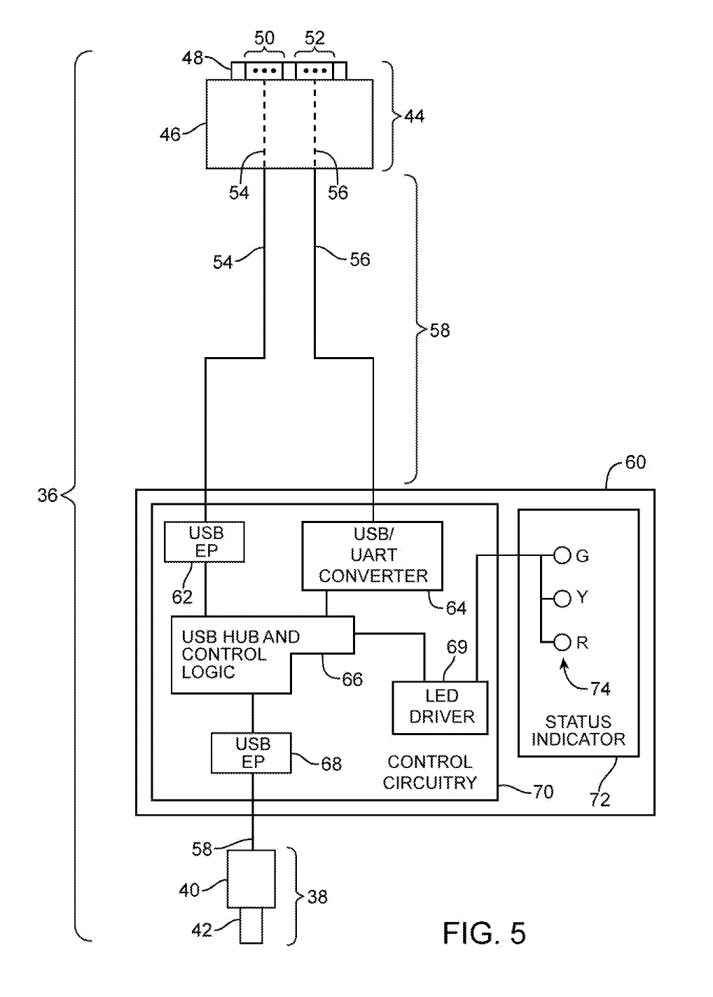

Following configuration of programmable integrated circuit 64′ using programming equipment 102, programmable integrated circuit 64′ may be referred to as USB-UART converter circuit 64, as shown in FIG. 5. Also shown in FIG. 5, following configuration of programmable integrated circuit 69′ using programming equipment 102, programmable integrated circuit 69′ may be referred to as LED driver 69 (or as General Purpose Input-Output converter circuit 69). Following configuration of assembled test cable 36′ using programming equipment 102, assembled test cable 36′ may be referred to as assembled programmed test cable 36, test cable 36, programmed cable 36, etc.

An illustrative assembled and programmed cable is shown in FIG. 5. As shown in FIG. 5, cable 36 may have a first end that is terminated with connector 38 and an opposing second end that is terminated with connector 44. Connector 38 may be a USB connector having a housing such as housing 40 that is used to house USB connector structure 42. Connector 44 may be a connector such as a 30-pin data connector. As shown in FIG. 5, connector 44 may have a connector housing such as housing 40 in which connector structure 48 (e.g., a 30-pin connector structure) is mounted. Connector structure 48 may be configured to mate with connector 24 of device under test 10 FIG. 1. When mated in this way, contacts (pins) 50 of connector 44 may mate with corresponding contacts 26 in connector 24 and contacts (pins) 52 of connector 44 may mate with corresponding contacts 28 in connector 24. Connector structure 48 may also mate with connector 112 of test board 106 of FIG. 2 during manufacture of test cable 36. In general, connectors 38 and 44 may be implemented using any suitable types of connectors (e.g., USB, mini USB, Firewire®, 30-pin, Ethernet, audio connectors such as TRRS connectors, video connectors such as DVI, VGA, and HDMI connectors, or other types of signal connectors). The use of USB and 30-pin connectors in the examples of FIGS. 1, 2, 3 4 and 5 is merely illustrative.

Connectors 44 and 38 may be coupled using cable paths 58. Cable paths 58 may include wires (e.g., wires bundled to form cables or other wired paths). Data conversion circuitry 60 may be interposed in the wired path between connectors 44 and 38. As shown in FIG. 5, at connector 44, cable path 58 may include wires such as wires 54 that are connected to contacts 50 in connector structure 48 and may include wires such as wires 56 that are connected to contacts 52 in connector structure 48. The portion of wired path 58 between connector 38 and circuitry 60 may include wires for coupling USB connector 38 to USB communications circuitry (USB endpoint) 68. Wired path 54 may be coupled to USB communications circuitry (USB endpoint) 62. Wired path 56 may be coupled to USB-UART converter 64.

Control circuitry 70 may use USB communications circuitry 62, USB-UART converter 64, USB communications circuitry 68, and USB hub and control logic circuitry 66 to create an interface between connector 38 and connector 44. USB traffic that is supplied to connector 38 from test equipment 104 (FIG. 2) may contain data that is destined to the USB portion of connector 44 (i.e., contacts 50), may contain data that is destined to led driver 69, and may contain data that is destined to the UART portion of connector 44 (i.e., contacts 52). Control circuitry 70 may route the traffic that is destined to the USB portion of connector 44 to USB communications circuit 62 through USB communications circuitry 68 and circuitry 66 for transmission to contacts 50. Control circuitry 70 may route the traffic that is destined to the UART portion of connector 44 to USB-UART converter 64 through USB communications circuitry 68 and circuitry 66. USB-UART converter 64 may convert incoming data using USB communications protocols to outgoing data to data using UART communications protocols suitable for communicating with UART circuitry 18 of FIG. 1 (e.g., during testing of a device under test) or for transmission to test board 106 (e.g., during testing of cable 36).

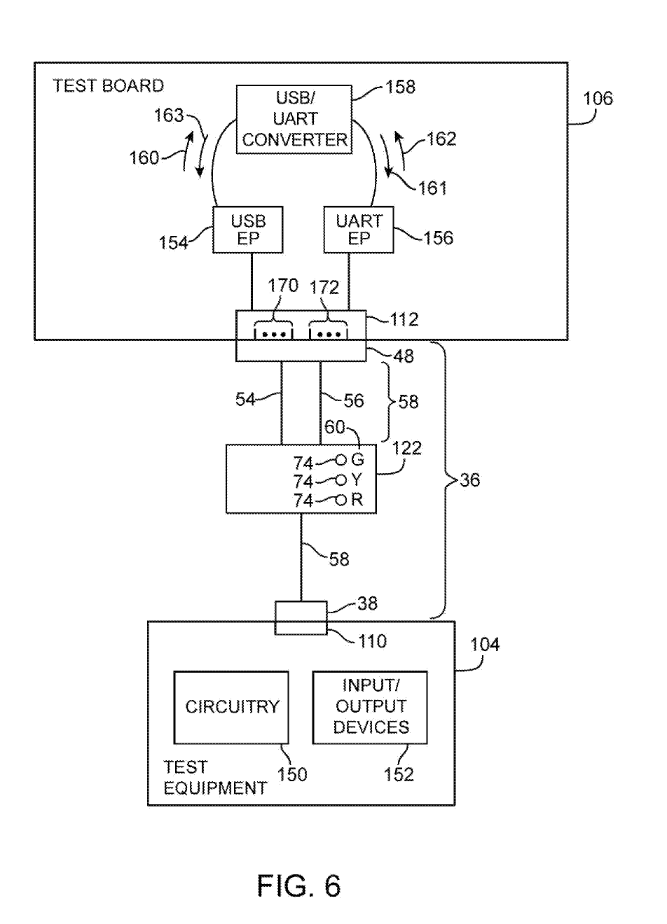

During testing, control circuitry 70 may route USB traffic from USB circuit 16 of device under test 10 and contacts 52 to connector 38 using USB communications circuitry 62, circuitry 66, and USB communications circuitry 68. Control circuitry 70 may route UART traffic from UART circuitry 18 (FIG. 1) to USB communications circuitry 68 via USB-UART converter 64 (which converts UART traffic into USB traffic) and circuitry 66. Control circuitry 70 therefore serves as an interface between the single communications bus (i.e., the USB bus) that is associated with connector 38 and the two communications buses (i.e., the USB bus and the UART bus) that are respectively associated with the two sets of contacts (50 and 52) in connector 44. Control circuitry 70 may also be configured to route USB traffic from USB communications circuitry 62 or 68, through circuitry 66, to LED driver 69 for turning on and off status indicator LEDs 74 during testing of device under test 10 (of FIG. 1) or during testing of cable 36 (see FIG. 6).

Status indicator 72 may be used for providing test status information to an operator of the test system during testing of device under test 10 or during manufacturing and testing of cable 36 as shown in FIG. 6.

FIG. 6 is an illustrative diagram of a portion of programming and test system 100 configured to test programmed (and assembled) test cable 36. As described in connection with FIG. 5, test cable 36 may include data conversion circuitry 60 mounted in housing 122 interposed between connectors 38 and 48 of cable 36.

Following assembly and programming of cable 36 as described in connection with FIGS. 3 and 4, respectively, connector 48 of cable 36 may be plugged into (i.e., mated with) connector 112 of test board 106 and connector 38 of cable 36 may be plugged into (i.e., mated with) connector 110 of test equipment 104. Connector 112 of test board 106 may include multiple different sets of contacts associated with different communications buses and different associated communications protocols. For example, test board 106 may use a first communications circuit such as USB communications circuit 154 (e.g., a USB endpoint) to handle USB communications through contacts 170 and may use a second communications circuit such as UART communications circuit 156 to handle UART communications through contacts 172. Using USB communications protocols and USB circuit 154, test board 106 can communicate over a USB bus coupled to contacts 170. Using UART communications protocols and UART circuit 156, test board 106 can communicate over a UART bus coupled to contacts 172.

Test board 106 may use USB/UART converter 162 to convert USB traffic from USB communications circuit 154 (as indicated by arrow 160 of FIG. 6) to UART traffic and to transmit the converted UART traffic to UART communications circuit 156 (as indicated by arrow 161). Test board 106 may also be configured to use USB/UART converter 162 to convert UART traffic from UART communications circuit 156 (as indicated by arrow 162) to USB traffic and to transmit converted USB traffic to USB communications circuit 154 (indicated by arrow 162).

USB and UART traffic that pass through USB/UART converter 158 of test board 106 (as indicated by arrows 161, 162, 163, and 164) may be generated and transmitted using test equipment 104 and routed through test cable 36. During loop-back testing, test data may be looped through converter 158 from path 54 and pins 170 to pins 172 and path 56 (as indicated by arrows 160 and 161) or may be looped through converter 158 from path 56 and pins 172 to pins 170 and path (as indicated by arrows 162 and 163). Test equipment 104 may include circuitry 150 and input-output devices 152. Circuitry 150 may be used to generate data and transmit data into to cable 36 to exercise components of data conversion circuitry 60 and status indicator 72. Input-output devices 152 may include speakers, microphones, sensors, buttons, keyboards, displays, touch sensors, wireless circuitry such as wireless local area network transceiver circuitry and cellular telephone network transceiver circuitry, and other components for receiving input and supplying output.

Circuitry 150 of test equipment 104 may be used to store or generate test data to be communicated using USB communications protocols into cable 36. Data may be passed through USB communications circuitry 68, USB hub and control logic circuitry 66 and USB communications circuitry 62 to test board 106. Test board 106 may be used to convert (with USB/UART converter 158) incoming data using USB communications protocols (e.g., USB data) to outgoing data using UART communications protocols (e.g., UART data). Outgoing data using UART communications protocols may then be passed into cable 36 along wires 56 to USB/UART converter 64 of control circuitry 70 (see e.g., FIG. 5) of cable 36. USB/UART converter 64 may be used to convert data received from test board 106 using UART communications protocols into data using USB communications protocols. The data using USB communications protocols from USB/UART converter 64 may be passed to USB HUB and control logic circuitry 66 and delivered to LED driver 69 which may be used to operate LEDs 74 of status indicator 72. During testing of test cable 36, LEDs 74 may be lit sequentially (e.g., blinked one after another) or may be lit simultaneously due to signals generated by test equipment 104, passed through cable 36, and looped back by test board 106 into cable 36 to indicate the success or failure of the test. As an example, during testing of cable 36, blinking of all LEDs 74 may indicate a verified test cable (i.e., a cable such as test cable 36 that has been verified to be in working condition). Failure of one or all LEDs 74 to light may indicate test failure (i.e., that one or more components of data conversion circuitry 60 or one or more portions of wired path 58 are not in working order).

The example described above in which data is generated using circuitry 150 of test equipment 104, passed into cable 36, passed through USB communications circuitry 68, USB hub and control logic circuitry 66, USB communications circuitry 62, test board 106 and looped back into cable 36 is merely illustrative. Other paths are possible for USB/UART traffic during testing of test cable 36 using test equipment 104, data conversion circuitry 60 of cable 36 and test board 106.

In another example, USB signal may be transmitted by test equipment 104 into cable 36, passed through USB communications circuitry 68 to USB hub and control logic circuitry 66 and passed to USB/UART converter 64. USB/UART converter 64 may be used to convert USB traffic from circuitry 66 to UART traffic. Converted UART traffic from USB/UART converter 64 may be passed to loop-back test board 106. UART traffic that is passed from cable 36 to test board 106 may be passed through UART communications circuitry 156 to USB/UART converter 158 in direction 162. USB/UART converter 158 may be used to convert UART traffic from UART communications circuitry 156 to USB traffic to be passed to USB communications circuitry 154 in direction 163. The USB traffic passed to USB communications circuitry 154 in direction 163 may be passed into cable 36 and through USB communications circuitry 62 to USB hub and control logic circuitry 66. USB HUB and control logic circuitry 66 may then deliver signals to LED driver 69 to operate LEDs 74 of status indicator 72. USB HUB and control logic circuitry 66 may also pass data using USB communications protocols to USB communications circuitry 68 to be passed to test equipment 104 for further analysis using circuitry 150 of test equipment 104.

As shown in FIG. 6, LEDs 74 of data conversion circuitry may be visible in housing 122 during testing of cable 36 using test equipment 104 and test board 106. As described above with respect to FIG. 6, during testing of test cable 36, LEDs 74 may be lit to indicate the success or failure of the test. As an example, the lighting of all LEDs 74 during testing of cable 36 may indicate a verified cable (i.e., a cable that has been verified to be in working condition). Failure of one or all LEDs 74 to light may indicate test failure (i.e., that one or more components of data conversion circuitry 60 or one or more portions of wired path 58 are not in working order).

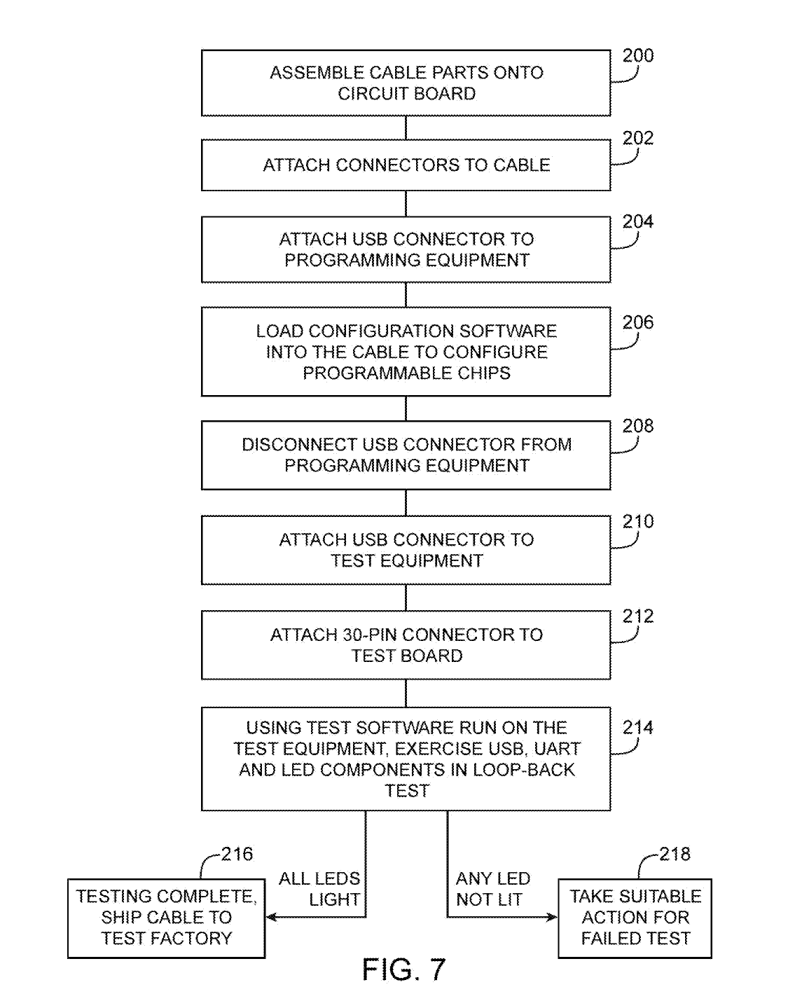

FIG. 7 is a flow chart of illustrative steps involved in using test system 100 of FIG. 2 during manufacturing and testing of test cable 36.

At step 200 cable parts such as USB hub and control circuitry 66, USB communications circuitry 62 and 68, programmable integrated circuits 64′ and 69′, wires for wired path 58 and LEDs 74 may be mounted on circuit board 120.

At step 202, connectors 38 and 44 may be attached on opposing ends of wired path 58 to form assembled cable 36′.

At step 204, assembled cable 36′ may be coupled to programming equipment 102 by plugging USB connector 38 of cable 36′ into connector 108 of programming equipment 102.

At step 206, programming equipment 102 may be used to load configuration software into assembled cable 36′ in order to configure programmable integrated circuit 64′ (e.g., to convert incoming data using USB or UART communications protocols to outgoing data using UART or USB communications protocols respectively) and to configure programmable integrated circuit 69′ (e.g., to convert incoming data using USB communications protocols to General Purpose Input-Output (GPIO) signals). Following configuration of assembled test cable 36′ using programming equipment 102, assembled test cable 36′ may be referred to as assembled programmed test cable 36 or as test cable 36. Following configuration of test cable 36′ using programming equipment 102 during step 206, programmable integrated circuit 64′ may be referred to as USB-UART converter 64 and programmable integrated circuit 69′ may be referred to as LED driver 69.

At step 208, USB connector 38 of test cable 36 may be removed from connector 108 of programming equipment 102.

As step 210, USB connector 38 of test cable 36 may be connected to connector 110 of test equipment 104 for testing (verification) of test cable 36.

At step 212, connector 48 (e.g., a 30-pin connector) of cable 36 may be connected to connector 112 of test board 106 for testing of test cable 36.

At step 214, test software run using circuitry 150 of test equipment 104 may be used as described in connection with FIG. 6 (i.e., using loop-back test board 106 to loop data from cable 36 back into cable 36 to operate LEDs 74) to exercise USB circuitry 162 and 68, USB hub and control circuitry 66, USB/UART converter 64, LED driver 69, LEDs 74 and, if desired, other components of test cable 36. During testing of test cable 36 with test equipment 104 and test board 106, LEDs 74 may be operated (turned on and off) using LED driver 69. Failure of all LEDs to light in response to signals generated by test equipment 104 and passed through test board 106 may indicate test failure. For example, the failure of the LEDs (or other status indicators) to properly respond to the test command that are send by the test station may indicate that one of the communications circuit associated with cable 36 is faulty, may indicate that the LED drivers or other circuitry associated with the status indictors is faulty, or may otherwise indicate the presence of faults in cable 36.

If it is determined that cable 36 contains one or more defects, the testing and manufacturing of test cable 36 may proceed to step 218. At step 218, test cable 36 may be repaired, discarded or other suitable action may be taken. If all LEDs 74 light successfully during testing of test cable 36, test cable 36 may be considered to have passed testing. Actions appropriate for satisfactorily manufactured cables may then be taken. For example, when it has been determined that a cable is performing satisfactorily, the cable may be used as a test cable to test devices under test in a manufacturing facility or may be used in performing other cable functions.

The foregoing is merely illustrative of the principles of this invention and various modifications can be made by those skilled in the art without departing from the scope and spirit of the invention.

What is claimed is:

1. A method, comprising:
coupling a cable between test equipment and a test board, wherein the cable contains at least one programmable integrated circuit that has been loaded with configuration data to program the integrated circuit; and
performing loop-back tests on the cable using the test equipment and the test board, wherein performing the loop-back tests comprises transmitting test data from the test equipment to the test board through the cable, transmitting the test data back from the test board to the test equipment using the test board.

2. The method defined in claim 1 wherein performing the loop-back tests comprises conveying the test data through the programmable integrated circuit.

3. The method defined in claim 2 wherein the cable includes at least one status indicator and wherein performing the loop-back tests comprises transmitting test data from the test equipment to the cable that directs the cable to activate the at least one status indicator.

4. The method defined in claim 3 wherein the at least one programmable integrated circuit comprises at least one General Purpose Input-Output pin and wherein performing the loop-back tests comprises transmitting the test data from the test equipment through the cable to the test board and from the test board back to the cable to direct the programmable integrated circuit to activate the at least one status indicator using the General Purpose Input-Output pin.

5. The method defined in claim 4 wherein the at least one status indicator comprises a light-emitting diode and wherein transmitting the test data from the test equipment through the cable to the test board and from the test board back to the cable to direct the programmable integrated circuit to activate the at least one status indicator using the General Purpose Input-Output pin comprises transmitting the test data from the test equipment through the cable to the test board and from the test board back to the cable to direct the programmable integrated circuit to illuminate the light-emitting diode using the General Purpose Input-Output pin.

6. The method defined in claim 4 wherein the at least one status indicator comprises a light-emitting diode, wherein the cable includes an additional programmable integrated circuit, and wherein transmitting the test data from the test equipment through the cable to the test board and from the test board back to the cable to direct the programmable integrated circuit to activate the at least one status indicator using the General Purpose Input-Output pin comprises transmitting the test data through the additional programmable integrated circuit.

7. The method defined in claim 6 further comprising programming the additional programmable integrated circuit to form a Universal Serial Bus to Universal Asynchronous Receiver Transmitter converter circuit.

8. The method defined in claim 7 further comprising programming the at least one programmable integrated circuit to form a Universal Serial Bus to General Purpose Input-Output converter circuit.

9. The method defined in claim 1 further comprising programming the at least one programmable integrated circuit to form a Universal Serial Bus to General Purpose Input-Output converter circuit.

10. The method defined in claim 1 further comprising programming the at least one programmable integrated circuit to form a Universal Serial Bus to Universal Asynchronous Receiver Transmitter converter circuit.

11. The method defined in claim 1 wherein the test board comprises a Universal Serial Bus to Universal Asynchronous Receiver Transmitter converter circuit and wherein performing the loop-back tests on the cable using the test equipment and the test board comprises conveying the test data through the Universal Serial Bus to Universal Asynchronous Receiver Transmitter converter circuit on the test board.

12. The method defined in claim 1 further comprising:
coupling the cable between device under test test equipment and a device under test following successful loop-back testing of the cable; and
testing the device under test using the device under test test equipment.

13. A system for testing a cable having first and second connectors and at least one programmable integrated circuit through which signals are conveyed during use of the cable, the system comprising:
test equipment to which the first connector of the cable is coupled; and
a loop-back test board to which the second connector is coupled, wherein the loop-back test board comprises a Universal Serial Bus to Universal Asynchronous Receiver Transmitter converter circuit through which test data is conveyed when performing loop-back tests on the cable using the test equipment and the loop-back test board.

14. The system defined in claim 13 wherein the test equipment and loop-back test board are configured to convey the test data through the programmable integrated circuit during testing.

15. The system defined in claim 14 wherein the cable includes at least one status indicator and wherein the test equipment and the loop-back test board are configured to perform the loop-back tests by transmitting the test data from the test equipment to the cable to direct the cable to activate the at least one status indicator.

16. The system defined in claim 15 wherein the at least one programmable integrated circuit comprises at least one General Purpose Input-Output pin and wherein the test equipment and the loop-back test board are configured to perform the loop-back tests by transmitting the test data from the test equipment to the cable through the loop-back test board to direct the programmable integrated circuit to activate the at least one status indicator using the General Purpose Input-Output pin.

17. The method defined in claim 15 wherein the at least one status indicator comprises a light-emitting diode and wherein the test equipment and loop-back test board are configured to transmit the test data from the test equipment to the loop-back test board through the cable and from the loop-back test board back to the cable to direct the programmable integrated circuit to illuminate the light-emitting diode using the General Purpose Input-Output pin.

18. A loop-back testing board for testing a cable, comprising:
a connector that receives a mating connector on the cable;
a first set of contacts connected to corresponding first contacts in the mating connector;
a second set of contacts connected to corresponding second contacts in the mating connector; and
a Universal Serial Bus to Universal Asynchronous Receiver Transmitter converter circuit configured to convey test data when performing loop-back tests on the cable using test equipment and the loop-back testing board.

19. The loop-back testing board defined in claim 18 wherein first set of contacts comprises Universal Serial Bus contacts configured to receive Universal Serial Bus data from a Universal Serial Bus path in the cable.

20. The loop-back testing board defined in claim 19 wherein second set of contacts comprises Universal Asynchronous Receiver Transmitter contacts configured to receive Universal Asynchronous Receiver Transmitter data from a Universal Asynchronous Receiver Transmitter path in the cable.
